(19) United States
(12) Patent Application Publication
(10) Pub. No.: US 2010/0033425 A1
(43) Pub. Date: Feb. 11, 2010

(54) COMPUTER PERIPHERAL DEVICE INTERFACE FOR SIMULATING MOUSE, KEYBOARD, OR GAME CONTROLLER ACTION AND METHOD OF USE

(76) Inventors: Judith Shasek, Bend, OR (US); Kevin Coburn, Greeley, CO (US)

Correspondence Address: CLARK & BRODY, 1090 VERMONT AVENUE, NW, SUITE 250, WASHINGTON, DC, 20005, US

(21) Appl. No.: 12/534,235

(22) Filed: Aug. 3, 2009

Related U.S. Application Data
(60) Provisional application No. 61/129,993, filed on Aug. 5, 2008.
(60) Provisional application No. 61/136,620, filed on Sep. 19, 2008.

(51) Int. Cl. G09G 5/00; A63F 9/24

(52) U.S. Cl. 345/156; 463/36

(57) ABSTRACT

A computer peripheral device interface includes a microprocessor and unique coding /USB functionality to enable a foot, feet, hands, body computer peripheral device to have the capability to function as each of programmable mouse, joystick, and/or keyboard. The inventive peripheral device interface can include a communications channel to support various custom peripherals to be linked from or to the platform or other computer peripheral device, i.e. platform, pad, cycle, balance apparatus.

This application claims priority under 35 U.S.C. §119(e) based on provisional application Ser. Nos. 61/129,993 filed on Aug. 5, 2008 and 61/136,620, filed on Sep. 19, 2008.

### FIELD OF THE INVENTION

The invention relates to the fields of interactive computer games and software, computer input devices and computer related exercise, and particularly to an interface that permits a computer peripheral device such as a foot, feet or hand pressure-activated device to operate as a mouse, keyboard, or game controller so as to operate applications on a computer by communicating with a foot-body activated user input peripheral device via a board-chip interface.

### BACKGROUND OF THE INVENTION

Dance Pads/Mats style peripherals with switch-activated areas are used to play “four-arrow matching type games” and dance-video games (i.e., Dance Dance Revolution, Konami). These pads typically consist of a 3×3 array of squares. All, but the center square contain a pressure sensitive switch that is activated when stepped on and deactivated when released. Dance pads contain a microcontroller to communicate the state of the switches to the game console or computer. Videogames on the computer or game console can monitor the state of the switches, enabling the pad to interact with the game. Dance Pads are limited to be used with “four-arrow matching type games” and dance-type games, of which there are very few. The Dance Pad or platform cannot be used to play the vast majority of computer games or software.

Standard computer input devices are also known and are used in connection with computer systems support the use of many input devices. The keyboard and mouse are the primary human input devices to a computer system. These devices provide no health benefit or whole body physical activity or balance practice to the user. In fact, they can adversely affect the health of the user (carpal tunnel syndrome) and as a result of the many daily hours of “screen”/computer sedentary practice.

The personal computer game bike is another peripheral device used in connection with computer systems. One example is PCGamerBike, see www.pcgamerbike.com, which is a system that links an exercise bike to a computer. This system maps your forward and reverse pedal motion to a keyboard, mouse or joystick activity. While the system works well for playing certain types of personal computer (PC) games, it is not capable of interfacing with other PC games. Thus, it is not a replacement for other input devices (mouse, keyboard or game controller such as a joystick) that are required to play other PC games. PC game bikes are limiting in that there are only two actions that can be mapped to input device actions; forward and reverse pedal motion.

In light of the problems noted above regarding the limited applications for dance pads, health issues raised by the sedentary practice of playing computer games, and the limited applications for PC game bikes, a need exists to provide more opportunities to computer game users to avoid the sedentary effects of extended computer use. The present invention responds to this need by providing a system and method that provides a computer peripheral device interface that allows a user to connect a peripheral device such as a dance pad/platform to a computer so that the peripheral device functions like a computer mouse, joystick, keyboard or other conventional peripheral device so that any application can be utilized using the interface and dance pad or other non-conventional computer peripheral.

### SUMMARY OF THE INVENTION

The present invention, in one embodiment, is a computer peripheral device interface that includes a set of coding, a microprocessor or chip, and a board. The interface can also include a communications channel to support various custom peripherals. One example of a computer peripheral device is a dance pad/platform that can act as a standard input device to a computer system or game console. The dance pad can be equipped with the inventive computer peripheral device interface, i.e., board/chip/coding and a USB port. Once so equipped, the peripheral device can perform all of the functions of a computer mouse, joystick, game controller, or a keyboard. Said another way; the invention is, in one embodiment, a unique set of coding, a microprocessor, and a board that can include a communications channel that enables a dance pad (or similar peripheral device) to emulate a keyboard, a mouse, and/or a game controller. The action to the peripheral device by a user can involve a foot, feet, or hand(s) contact with surfaces of the peripheral device.

The invention has the ability to enable many game input devices (dance mats, cycles, balance or jumping apparatus) to communicate or interact with thousands of existing PC games and software. These game input devices are those that are not the conventional input devices like a keyboard, mouse, joystick, handheld game controllers, etc. The invention is in direct contrast, for example, to a dance pad that only works with a handful of dance video games (or four-arrow matching type games). These prior art peripheral devices, e.g., the dance pad or bike, lack the interface that allows the inputted action to the peripheral device, e.g., foot or hand action, to be translated to an input to a computer application.

The inventive computer peripheral device interface use is not limited to computer games. The invention could be used with any software program on a computer that requires a mouse, a joystick and/or select keyboard keys. The invention can be used alone or with other computer input devices (mouse, keyboard, joystick, tablet . . . ).

The invention enables a fitness/physical activity driven alternative to using standard computer input devices. It provides physical activity-driven input in an environment that is usually sedentary. This has shown to have many benefits to the computer user or casual gamer, including:

positive health and cognitive benefits

stress reduction

balance and agility practice

cross-lateral movement

opportunity for calorie burning—increase in non sedentary leisure play.

It should be understood that one aspect of the invention is make the dance pad or other peripheral device function like a mouse, keyboard, or game controller. One unique aspect of the invention is the capability to convert the action done to the peripheral device (user input to the device using a body part such as a foot or feet or balance) to simulate the action done to any of a mouse, keyboard, or game controller. Unlike other prior art devices like the PCGameBike, which is one-dimensional in its ability to translate back and forth pedal motion for operating a computer game program, the invention is not so limited. The inventive computer peripheral device interface provides the capability for the computer peripheral device to function like each of a mouse, keyboard, or game controller. This provides a much more expansive capability for the computer peripheral device to work with a variety of computer applications, not just games. If the computer application requires keyboard input, this can be accomplished through a dance pad, as an example, when connected to the inventive computer peripheral device interface. Likewise, a program requiring mouse input can be run using a physical activity-driven peripheral and the inventive computer peripheral device interface.

### BRIEF DESCRIPTION OF THE DRAWINGS

FIG. 1 is a schematic of one embodiment of the invention showing various hardware components in block representation.

FIG. 2 shows a top view of an exemplary device that can be linked to a computer using the inventive interface.

FIG. 3 is an alternative embodiment which employs a balance board instead of the pad of FIG. 2.

### DETAILED DESCRIPTION OF THE INVENTION

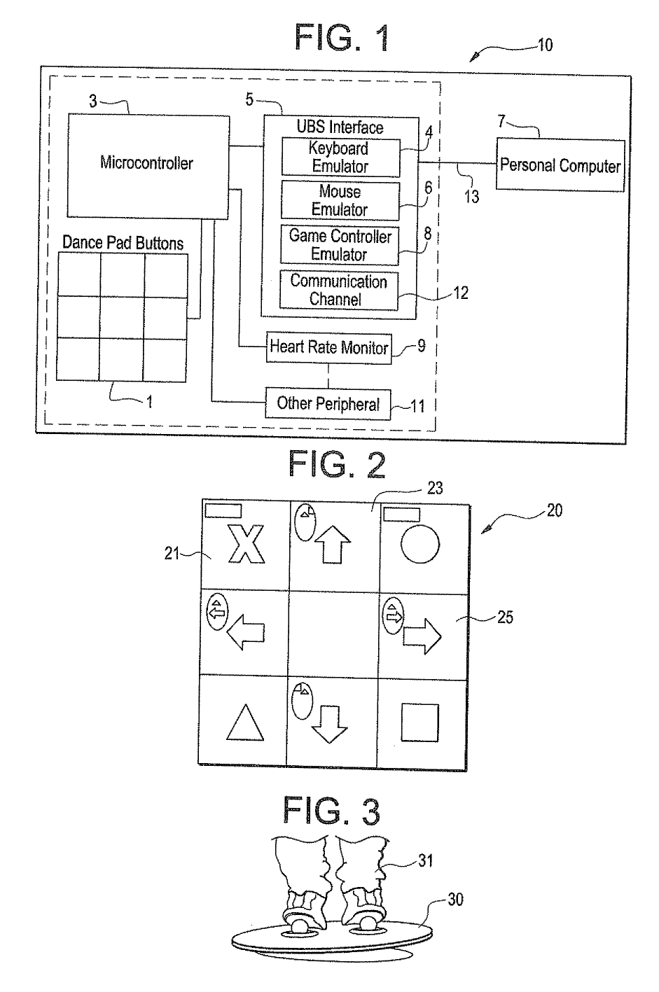

FIG. 1 shows one embodiment of the invention, which includes features of the invention as well as other components. The overall system is designated by reference numeral 10. A dance pad 1 is shown in communication with a microcontroller 3. A USB interface 5 is provided, the interface 5 providing communication between the microcontroller 3 and a personal computer 7. The USB interface includes a keyboard emulator 4, a mouse emulator 6, a game controller emulator 8, and a communication channel 12. The emulators permit the input from the dance pad to emulate a mouse, keyboard, game controller or the like. In this way, for example, the computer sees the interface, microcontroller, and dance pad as a mouse input, which allows a program on the computer to be operated by the dance pad, which emulates a mouse movement.

Also shown in FIG. 1 are other peripheral devices that can be linked to the microcontroller such as a heart rate monitor 9. Additional peripherals can be used as explained below and are designated by reference numeral 11. The other peripherals can include a step/motion logging monitor for example or any other peripherals that could use the data or information from the microcontroller.

A USB cable 13 is shown linking the computer 7 and the interface 5. However, any other type of communications link could be used, either wired or wireless.

The microcontroller monitors the state of the physical activity driven peripheral device, for example dance pad buttons. The microcontroller converts (maps) the activity input, i.e. switch presses on a dance mat, to computer input device ations, such as,

1. keyboard key strokes,

2. mouse button clicks, mouse wheel motion, or mouse motion.

3. Game controller actions. Button presses, joystick movements

4. Logging of the physical activity, i.e. steps, heart rate, jumps.

Other peripherals can be added to the activity driven peripheral, such as a heart rate monitor allowing exercise data collection via the invention. The communication channel supports two-way communication between the software program of the personal computer and the microcontroller.

In one example of a hardware embodiment of the invention, the invention can be connected to a conventional dance platform peripheral. The invention allows each button to be independently mapped to an action on the input device. An example of a hardware embodiment is shown in FIG. 2. This Figure illustrates a dance pad 20, which may be 3 feet×3 feet, with an arbitrary set of mappings. In one embodiment, stepping on the “X” button 21 will emulate the press of the “A” key on the keyboard. Another mapping can be stepping on the Up-Arrow button 23 to emulate a right mouse-button click. Another example is stepping on the Right-Arrow button 25 to cause the mouse cursor to move to the right. In yet another type of mapping, pressing a dance pad button press could result in the emulation of joystick movement, or game controller key press.

While a dance pad is shown as one device to be used with the microcontroller 3 and interface 5, these components do not have to be connected to the computer via a dance pad. Instead, other devices that generate a signal based on a user input could be used. Examples include
Balance board or stationary skate board. The tilt of the board could be translated to mouse motion. The direction of tilt controls the direction of the mouse. An example of a balance board is shown in FIG. 3, wherein the board is designated by the reference numeral 30 and a user is shown as reference numeral 31. The user can move the balance board in any number of directions and this movement is communicated to the microcontroller and interface, which in turn maps it to the desired peripheral motion for use by the computer 7.
Any other non-conventional peripheral device, a device other than the standard keyboard, mouse, game controller or joystick, that would convert a user's feet, body or hand motion to simulate the movement of a mouse or action on a keyboard to operate an application on the computer linked to the non-conventional peripheral device using the inventive computer peripheral device interface.

The communication channel 12 enables two way communication between the microcontroller 5 and the software running on the computer system. This enables the addition of diverse peripherals to the peripheral device being linked to a computer using the inventive computer peripheral device interface. The type of peripherals are limited only by the imagination. A few examples are,
1. Switch activation logging that counts each input action similar to pedometer step-counting with onscreen logging that calibrates “steps” as calories burned, miles traveled, points for games, or online web portal reward.
2. A Heart Rate monitor.
3. Speakers.
4. Lights.
5. Custom dance pad buttons. For instance, a button could be replaced with a joystick or a force sensitive analog button. A button could have an LCD screen or other display device under it.
6. Force-feedback. For instance, a button could vibrate when you step on it when it shouldn't be stepped on. Other devices providing an audio output could be employed as well.

Another peripheral involves monitoring heart rate based on the user input. Steps, jumps and balance motion from the user, as well as heart rate information can be sent to a software program using an existing dance pad or other electronic computer peripheral device. For example, to a software program, a USB dance pad looks like a game controller with 9 buttons. Game controllers can have many more buttons. To monitor the heart rate of a user, the microcontroller can use a button press on the computer peripheral device, e.g., pressing on the pads (switches) of the dance pad, in order to estimate the heart rate of the user. The software program could then measure the number of times the switch in the computer peripheral device is pressed and/or the time between the presses of the switch to estimate the heart rate of the user and display and/or save the information for the user. The user could also wear a chest strap or other heartbeat monitor and this monitor could be linked to the computer using the communications channel for a more accurate measure of the heart rate or other physiological condition of the user when engaging the computer peripheral device.

The input of the user can also be used for other purposes. For example, the input of the user to the device can be characterized as steps or some other nomenclature and these steps can then be converted into a more meaningful value for different purposes. In one mode, the steps can be converted to a value representing calories burnt during use of the device. In another mode, the steps can replicate a pedometer, with the steps being converted to distance traveled. In yet another mode, the number of steps can be tabulated as game points for competition purposes, or the steps can be tabulated to reward the user with something of relevance or value, virtual or real products, discounts or game/online community status, wellness incentives and the like. The rewards program can be similar to that used by many web portals, and virtual social online environments. These steps and/or the converted indicator of the steps made can be displayed on the screen via a step logging application that would be installed on the computer linked to the peripheral device. The logging application can also keep track of the steps as they would relate to the various modes described above, with the capability to display the steps and/or converted value as well as communicate the information with a remote server so that the steps of various users can be stored for comparative use as well as other uses based on how the steps are converted and used.

While the invention is described in terms of linking the device interface as the means for taking the output of the dance pad or other peripheral device and simulating this output as the output of a game controller, mouse, or keyboard for input to a computer to control a software program such as a game, educational program or the like, it is possible that the means for taking the output of the dance pad or other computer peripheral device can be made part of the computer itself. That is, the computer would have the necessary software as part of its microprocessor in order to receive the output from the dance pad and map it as a mouse, keyboard, game controller for control of a program residing on the computer. In this embodiment, the output of the dance pad would connect to the computer via a USB port or the like, and the computer itself would have the features disclosed in FIG. 1 to practice the invention. In this embodiment, there would be no need for communication, e.g., the USB port connection, between the computer and the microprocessor and interface as shown in FIG. 1 since these features would be part of the computer/computer programming.

As such, an invention has been disclosed in terms of preferred embodiments thereof which fulfills each and every one of the objects of the present invention as set forth above and provides a computer peripheral device interface for simulating mouse, keyboard, or game controller action and method of use. Of course, various changes, modifications and alterations from the teachings of the present invention may be contemplated by those skilled in the art without departing from the intended spirit and scope thereof. It is intended that the present invention only be limited by the terms of the appended claims.

We claim:

1. A method of converting input to a computer peripheral device to an output corresponding to a game controller, a mouse, and a keyboard for use with a computer comprising:
providing a computer peripheral device interface adapted to receive output signals from the computer peripheral device, the computer peripheral device interface capable of converting the output signals from the computer peripheral device into peripheral device output signals corresponding to one of a game controller, a mouse, and a keyboard, wherein action of a foot, feet, or other body part to the computer peripheral device relates to a specific action to the game controller, mouse, or keyboard;
outputting the peripheral device output signals to an application on the computer so that input to the computer peripheral device is sensed by a computer application as specific input action from one of the mouse, the game controller or the keyboard in order to control the application on the computer.

2. The method of claim 1, further comprising providing a communication channel between the computer peripheral device interface and the computer so that other peripheral devices can be added and controlled by input to the computer peripheral device.

3. The method of claim 1, wherein the computer peripheral device is a dance or foot pad or a balance, jumping or pedaling apparatus.

4. The method of claim 1, further comprising monitoring a number of inputs to the computer peripheral device by a user and relating the number of inputs to a heart rate of the user or monitoring the heart rate of the user while using the computer peripheral device interface.

5. The method of claim 4, further comprising displaying and/or indicating various physical input: steps, heart rate, jumps or other action through the computer, the computer peripheral device or an indicator separate from the computer or the computer peripheral device.

6. The method of claim 1, wherein the computer peripheral device interface is part of the computer peripheral device or the computer.

7. The method of claim 1, further comprising outputting signals from the computer peripheral device interface to one or more additional indicator peripheral devices such as audio devices, video devices, motion devices, and lights.

8. The method of claim 1, wherein the computer is a personal computer.

9. A system for of converting input from a computer peripheral device to an output corresponding to each of a game controller, a mouse, and a keyboard for use with a computer comprising:
means for mapping input from the computer peripheral device into a peripheral device output signal that corresponds to one or more of a game controller, a mouse, and a keyboard, wherein action of a foot, feet, or other body part to the computer peripheral device relates to a specific action to the game controller, mouse, or keyboard;
means for outputting the peripheral device output signal to a computer application so that input to the computer peripheral device is sensed by the computer application as specific input action from one of the game controller, the mouse, or the keyboard in order to control the computer application on the computer.

10. The system of claim 9, wherein the means for mapping includes a communication channel so that other peripheral devices can be added and controlled by input to the computer peripheral device.

11. The system of claim 9, further comprising means for collecting data related to monitoring a number of inputs to the computer peripheral device by a user and relating the number of inputs to a heart rate of the user or monitoring the heart rate, or other data relevant to the user, while using the computer peripheral device.

12. The system of claim 11, further comprising displaying/indicating the heart rate through the computer, the computer peripheral device or an indicator separate from the computer or the computer peripheral device.

13. The system of claim 9, wherein the means for mapping and outputting are part of the computer peripheral device or the computer.

14. The system of claim 9, further comprising one or more peripheral devices such as audio devices, video devices, motion devices, and lights adapted to be controlled by input to the computer peripheral device.

15. In a computer peripheral device for use with a computer application, the improvement comprising the system of claim 1 in combination with the computer peripheral device.

16. The combination of claim 15, wherein the computer peripheral device is a dance or foot pad, pedaling, jumping or balance apparatus.

17. The method of claim 1, further comprising monitoring a number of inputs to the computer peripheral device made by user and relating the number of inputs as steps, so that the steps can be converted into an indicator such as calories burned, miles traveled, game points, a reward value and the like.

18. The system of claim 9, further comprising means for monitoring a number of inputs to the computer peripheral device made by user and relating the number of inputs as steps, so that the steps can be converted into an indicator such as calories burned, miles traveled, game points, a reward value and the like.

19. The method of claim 17, further comprising displaying the steps for the user and/or storing the steps remotely for further use.

20. The system of claim 18, further comprising means for displaying the steps for the user and/or storing the steps remotely for further use.

21. The method of claim 1, wherein the computer application is a game or educational application.

22. The system of claim 1, wherein the outputting means outputs the peripheral device output signal to a computer application as a game or educational application.
